(19) United States
(12) Patent Application Publication
(10) Pub. No.: US 2016/0082596 A1
(43) Pub. Date: Mar. 24, 2016

(54) MOBILE MEDICAL APPARATUS

(71) Applicant: SIEMENS AKTIENGESELLSCHAFT, MUENCHEN (DE)

(72) Inventors: KARL BARTH, HOECHSTADT (DE); ALEXANDER GEMMEL, ERLANGEN (DE); SULTAN HAIDER, ERLANGEN (DE); GERHARD KLEINSZIG, FORCHHEIM (DE); WEI WEI, ERLANGEN (DE); MARKUS WEITEN, NUERNBERG (DE)

(21) Appl. No.: 14/860,942

(22) Filed: Sep. 22, 2015

(30) Foreign Application Priority Data
Sep. 22, 2014 (DE) 102014219077.0

(51) Int. Cl. B25J 9/16; B25J 9/00; B25J 5/00

(52) U.S. Cl. CPC B25J 9/1689; B25J 5/00; B25J 9/1676; B25J 9/0081; Y10S 901/01

(57) ABSTRACT

A mobile medical apparatus contains a movement device for a moving the entire apparatus. The mobile medical apparatus has a detection device for detecting the movement of the apparatus, a storage device for storing information describing the movement of the apparatus, and a control interface for inputting a control command to the apparatus for repeating a movement in accordance with information describing the movement of the apparatus.

### CROSS-REFERENCE TO RELATED APPLICATION

This application claims the priority, under 35 U.S.C. § 119, of German application DE 10 2014 219 077.0, filed Sep. 22, 2014; the prior application is herewith incorporated by reference in its entirety.

### BACKGROUND OF THE INVENTION

### Field of the Invention

The invention relates to a mobile medical apparatus.

Diverse apparatuses for diagnosis or treatment are used in medical practice, these apparatuses being made available as required. For their use, these apparatuses are typically brought from a rest or parked position to a use position and, following the use, are transported back to the original position again. One example of such a mobile apparatus is a mobile C-arm. Mobile C-arms are used as an X-ray imaging apparatus in surgery, for example, but are required there only for a relatively short time, in order to image the tissue to be treated, e.g. for better localization of a tumor. Other apparatuses that are provided as required are e.g. therapeutic apparatuses such as RF apparatuses, laser apparatuses or various types of irradiation apparatuses. Such apparatuses are often provided with motorization in order to facilitate transport. In many cases, the positioning of a mobile apparatus for diagnosis or treatment is an elaborate and complex undertaking. Devices for positioning a medical apparatus are described for example in published, non-prosecuted German patent applications DE 10 2012 217 072 A1 (corresponding to U.S. patent publication No. 2014/0086393) and DE 10 2011 005 439 A1.

European patent EP 1 246 566 B1 (corresponding to U.S. Pat. No. 6,814,490) presents a C-arm system in which the end position of the movable apparatus and the projection of the C-arm are stored and can be moved to repeatedly. However, no movement information is stored, and so the movement used to bring about the previously stored end position of the apparatus and the position of the C-arm for the stored projection can lead to problems.

Furthermore, reference is made to published, non-prosecuted patent applications DE 10 2011 005 439 A1, DE 10 2005 049 106 A (corresponding to U.S. Pat. No. 8,767,920), EP 2 380 496 A1 (corresponding to U.S. Pat. No. 8,666,585), EP 0 087 198 A2 (corresponding to U.S. Pat. No. 4,578,757) and WO 2014/139023 A1 (corresponding to U.S. patent publication No. 2015/0109427). There is a need to improve the positioning of mobile medical apparatuses for diagnosis or therapy.

### SUMMARY OF THE INVENTION

It is accordingly an object of the invention to provide a mobile medical apparatus that overcomes the above-mentioned disadvantages of the prior art devices of this general type.

The invention is based on the observation that a repositioning is required relatively frequently in the case of mobile medical apparatuses. In this case, it is often necessary for this repositioning to be carried out with a certain accuracy in order to ensure an efficient examination.

Therefore, a mobile medical apparatus is proposed which is configured for supporting a repositioning. The mobile medical apparatus according to the invention contains movement devices (e.g. wheels or e.g. rails for the movement along a ceiling mount) provided for a movement of the entire apparatus. Furthermore, a detection device for detecting the movement of the apparatus is provided. The detection device and further detection devices described in the course of other configurations can be arranged either in the mobile medical apparatus itself or outside the apparatus. The detection of the movement of the apparatus can, for example, be information regarding a distance covered. In this case, it is also conceivable for information regarding a distance actually covered to be reduced for the storage of information related to an effective movement. In this case, the effective movement is the shortest distance to be covered which corresponds to the end points of a path, wherein there may be boundary conditions regarding possible paths. It is likewise possible for merely only specific positions or points to be detected, for example a two-tuple consisting of a start point and an end point.

Furthermore, a storage device for storing information describing the movement of the apparatus is provided. The storage device and furthermore storage devices described in the course of the configurations can likewise be part of the mobile medical apparatus or be arranged outside this apparatus. In the case of a storage device arranged outside the apparatus, provision can be made for information relevant for the movement of the apparatus to be transmitted from the storage device to a receiving device of the apparatus, e.g. wirelessly.

Finally, a control interface for inputting a control command to the medical apparatus for repeating a movement in accordance with information describing the movement of the apparatus is provided. The apparatus can be configured, in response to the inputting of the control command, to automatically repeat the movement (for example with the aid of a motor arranged in the apparatus), or to output the information for a manually performed repetition of the movement. Both, automatic repetition and display of the information can also be carried out jointly.

The invention allows positions of the apparatus that were implemented earlier to be moved to again in a simplified manner. In this way, elaborate repositioning is at least partly avoided, which leads to a more efficient sequence and to a better workflow.

In accordance with one configuration, the mobile medical apparatus additionally contains a movable component (e.g. an arm with an emitter and/or a detector) which typically likewise has to be positioned for the diagnosis or treatment. In accordance with the development, provision is made of a detection device for detecting the movement of the component, a storage device for storing information describing the movement of the component, and a control interface for inputting a control command to the medical apparatus for repeating a movement in accordance with information describing the movement of the component. These can be the same elements (detection device, storage device, control interface) to be used for the overall movement of the system, or else elements provided separately therefrom.

This use of the concept according to the invention additionally for the positioning of a component allows simplified repetition of the entire movements of the apparatus and of the parts thereof that are required for a specific recording or treatment position. In particular, provision can be made of a detection system for detecting a combined movement consisting of a movement of the overall system and a movement of at least one component of the system, a storage system for storing information describing the combined movement, and a control interface for inputting a control command to the medical apparatus for repeating a combined movement in accordance with information describing the combined movement. The detection system can consist of one or a plurality of dedicated detection devices, with the storage system as well. This configuration allows a repetition of the combined movement with little complexity, in the case of which the operating personnel do not have to differentiate between movement of the overall system and movement of the individual component for the repetition of the treatment or of the therapeutic intervention.

In accordance with a further configuration, a detection device for detecting at least one parameter relevant for the diagnosis or treatment is provided. In addition, there is a storage device provided for storing the parameter relevant for a diagnosis or treatment. Finally, provision is made of a control interface configured for inputting a control command to the medical apparatus for repeating a diagnosis or treatment by the mobile medical apparatus using the parameter relevant for the diagnosis or treatment. Preferably, all parameters relevant for the diagnosis or treatment are detected and stored, such that the treatment step or diagnosis step can be completely repeated in response to the control command. This development makes it possible not only to adopt the original position of the apparatus again in a relatively simple manner, but also to reproduce the function or the operation of the apparatus in a previous diagnosis or treatment.

Configurations of the invention also relate to a control element of the apparatus, which is configured for inputting relevant control commands, and a device for avoiding collisions, which makes the repetition of a positioning more secure.

Other features which are considered as characteristic for the invention are set forth in the appended claims.

Although the invention is illustrated and described herein as embodied in a mobile medical apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of the positioning of a C-arm according to the invention;

FIG. 2 is a schematic illustration of the situation during the positioning of the mobile medical apparatus;

FIG. 3 is a diagrammatic, perspective view showing various degrees of freedom of a mobile C-arm;

FIG. 4 is an illustration of a control element for repeating functions;

FIG. 5 is a schematic illustration of the mobile medical apparatus according to the invention;

FIG. 6 is a diagrammatic, perspective view of the C-arm with the control element according to the invention; and

FIG. 7 is a diagrammatic, perspective view showing a positioning of the C-arm with a plurality of parked positions.

### DETAILED DESCRIPTION OF THE INVENTION

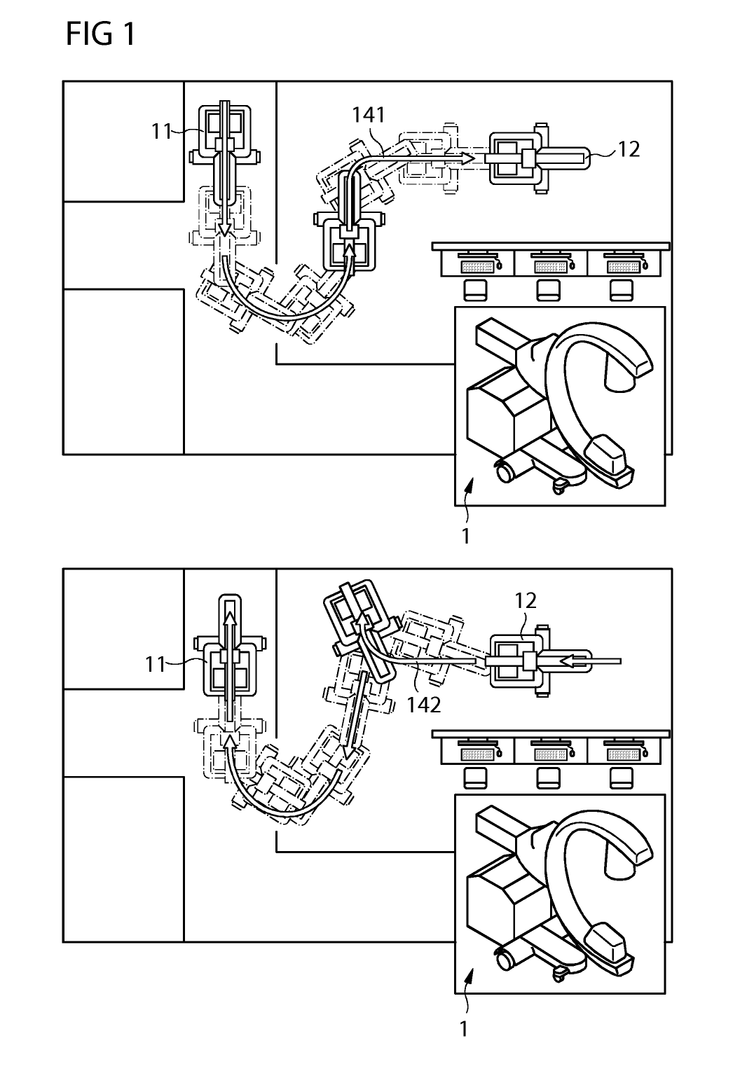

Referring now to the figures of the drawings in detail and first, particularly to FIG. 1 thereof, there is shown a C-arm 1, which in the top subfigure is transported from a parked position 12 via a path 141 to an end position or a target position 11. In the bottom subfigure, the mobile C-arm 1 is transported back from the target position 11 via a path 142 to the start position or the parked position 12. Such positioning processes have to be carried out many times for many mobile medical apparatuses in everyday clinical practice. This leads to a considerable complexity with regard to the work sequence or workflow and constitutes a considerable burden on the operating personnel. The invention proceeds from the observation that often identical positions have to be moved to repeatedly.

The invention therefore provides the equipment of mobile recording apparatuses with accurately controllable wheels, rolling elements (e.g. mecanum wheel) or the like and a storage device for storing different path positions. Here and hereinafter, position is understood to mean a position in addition to an angular position, e.g. in space or relative to the patient table. According to the invention, the apparatus is able to learn and store different positions and displacement paths and to move to the stored position again, as a result of which the surgeon or personnel is/are saved a great deal of effort (force and time) and the patient can be treated less invasively (faster deployment of the apparatus and therefore less exposure to radiation as a result of the desired recording position being found again rapidly, directly and accurately).

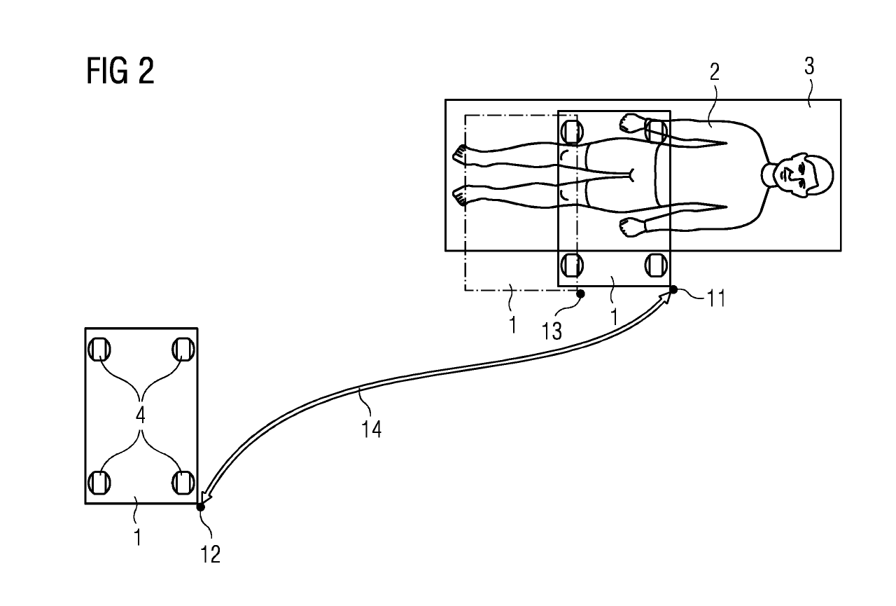

This is shown schematically in FIG. 2. The apparatus 1, e.g. the mobile C-arm, is initially situated at the parked position 12. The apparatus 1 is provided with an omnidirectional drive 4 (e.g. ball wheels), in order to enable a suitable movement in an arbitrary direction. From the parked position 12, the apparatus 1 is then moved to a patient table 3 and positioned e.g. by a laser targeting device (crosshairs) and/or transillumination for the final recording in a first position. With the use of motorization of the apparatus 1, the precise wheel steering positions and the associated location (transaction and orientation) of the C-arm can be stored for this position. After recording has been carried out in the first recording position 11, the apparatus is moved into a non-disturbing second position 13, the parked position (represented by broken lines in FIG. 2), e.g. by a remote control or by an easily operable lever (servo operation). During this movement, all control signals are logged and a path of the actual movement is thus at least intrinsically registered concomitantly, e.g. by counting pulses in the case of stepper motors, measurements of all wheel rotations, steering movements, etc. In addition, extrinsic measurements can also be performed in order to increase the accuracy (by use of navigation devices, conductor loops in the floor, . . . ).

If a new recording is then intended to be carried out, the control signals of the detected path are retrieved in an opposite order and the first position for the recording is thus moved to again automatically.

It is also possible for a plurality of recording positions to be stored and automatically moved to again (e.g. for “mosaicing”: movement sideways on the patient table, that is to say e.g. from the pelvis to the toes), as well as a plurality of parked positions.

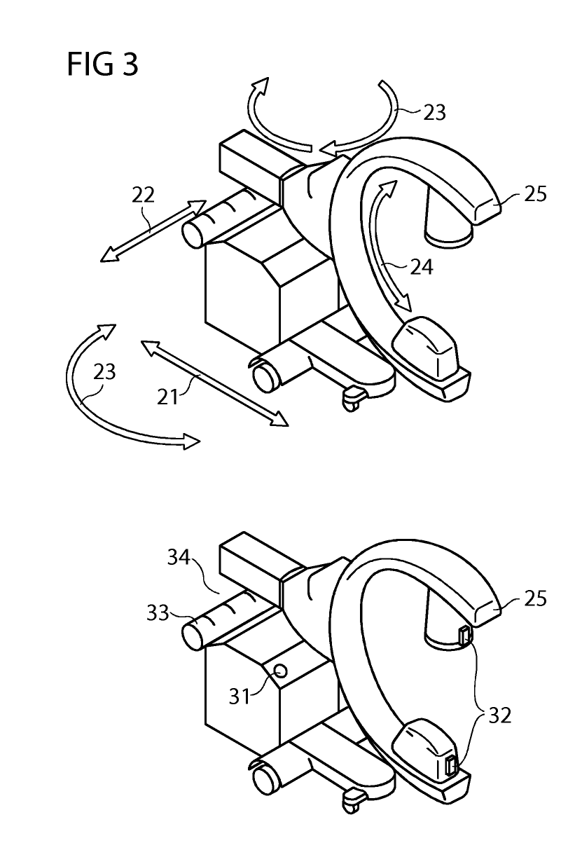

FIG. 3 shows degrees of freedom of the mobile C-arm. These comprise a horizontal movement 21 along a first horizontal direction; a horizontal movement 22 along a second horizontal direction, which is orthogonal to the first, a rotation 23 of the entire C-arm, an angular movement of the C-arm 23, and an orbital movement of the C-arm 24. All these degrees of freedom can be taken as a basis for the repetition of a movement sequence of the C-arm, i.e. a combined movement of the overall system (degrees of freedom 22, 23 and 21) and of the component given by an actual recording arm 25 (degrees of freedom 23 and 24) takes place here. The bottom view of FIG. 3 shows that the C-arm can be equipped with additional devices for supporting the repetition of recordings, e.g. with a collision prevention mechanism 31 and integrated cameras 32, e.g. for better alignment with the relevant irradiation zone (ROI, region of interest). In addition, a repetition function can be provided both for a path 33 and for an actual treatment 34.

Therefore, a programmable storage module and a motor are integrated in the C-arm and reproduce the path of the C-arm with regard to control, repositioning and the settings for the imaging. The integrated storage module learns the position and also the movements (e.g. up, down, orbital, angular) and the path taken of the operating personnel with the C-arm.

A control panel is preferably integrated in the C-arm, the control panel offering the functions described below.

The repetition of the recorded path is thus made possible. Particularly in the case of a renewed checking after an operation, it is advantageous if the original path was recorded and the recording position can be moved to again without any problems. This repetition function concerns the transversal and rotational movements of the entire C-arm system and the orbital, angular and horizontal movement of the C-arm component.

In addition, a function is provided which registers and stores parameters of the examination, e.g. the applied dose, the collimator settings, parameters for adjusting the system, etc.

In addition, the recording zone ROI or Region of Interest (including an image which is recorded by a camera and/or a detector integrated in the X-ray beam) can be stored as a stored parameter that is used, if appropriate, during the repetition.

Besides the recording functions, repetition functions can also be provided both for the path and for the imaging.

It can be provided that an individual set of information for the repetition of actions is stored and unambiguously referenced, such that the totality of the actions (or the entire corresponding workflow) can be repeated with one call. This set of information can contain movement information concerning the overall system, movement information concerning components of the system and settings of the system (e.g. recording parameters). The set of information can also relate to more than one modality or ancillaries (e.g. movement/parameter setting of patient couch).

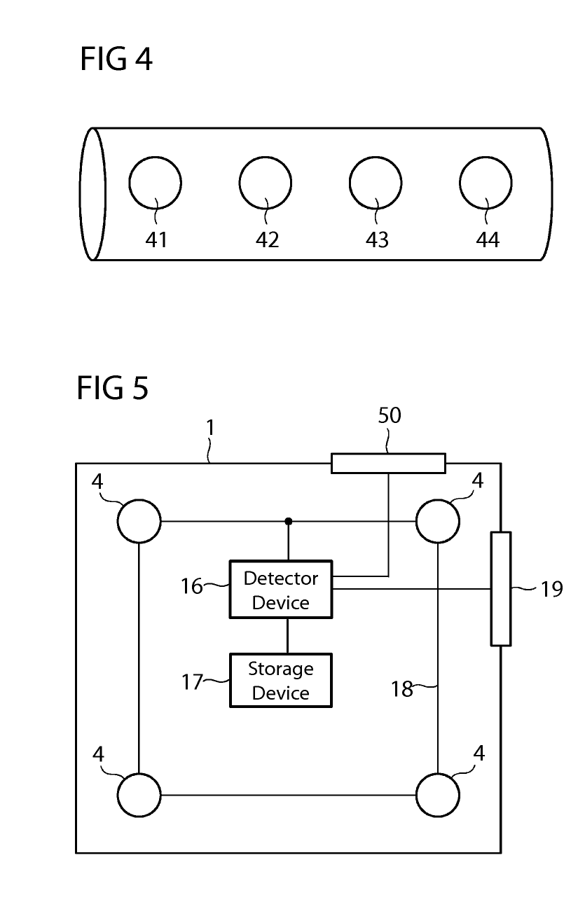

A corresponding control module is shown in FIG. 4 and has knobs enabling the respective function to be initiated. A recording function for the path 41, a function 42 for the parameter settings, a function 43 for the repetition of the path and a function 44 for the repetition of a recording with the stored parameters are involved here.

A further possible additional configurational feature is a collision avoidance system, e.g. on the basis of ultrasound or RFID technology. By way of example, when the C-arm is brought back to the parked position, the path can be blocked by a heart-lung machine or an ultrasound apparatus as an obstacle. Problems are avoided by virtue of the integrated collision avoidance, e.g. using ultrasonic sensors.

The system can be provided with a motor function and a storage function. The storage function has a learning interface and built-in programmable intelligent electronics. The motor is connected to at least one of the wheels of the C-arm and thus supports the control and the movement of the mobile C-arm.

A GPS system or a local positioning system (LPS) for identifying the original position of the C-arm system can also be provided. Such a system can provide support for determining the position of the C-arm with respect to the target position, e.g. parked position in the clinical facility. The position of the C-arm could additionally also be displayed at an operator interface on the C-arm.

In addition, sensors such as e.g. RFID, ultrasound, magnetic sensors, capacitive sensors, mechanical sensors, etc. can be provided which support the tracking of the movement of the C-arm.

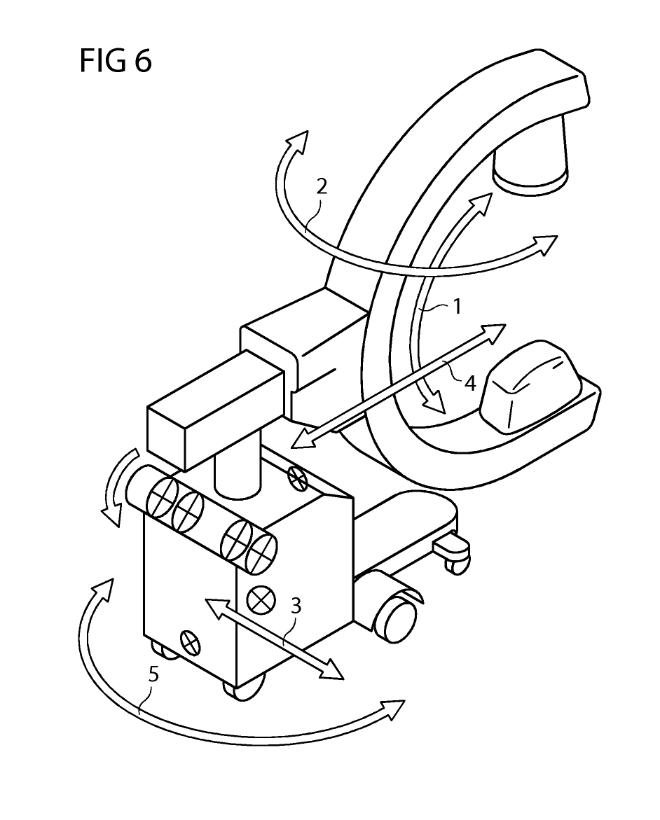

FIG. 5 shows a schematic illustration of the C-arm 1. A control interface 50 presented in FIG. 4 is connected to a control module 16. The control module 16 also serves for detecting the movement of the C-arm 1, i.e. constitutes a detection device. For detecting the movement, the control module or the detection device 16 is connected to the wheels 4. A bus system 18 is provided, by which movement information can be communicated from the wheels 4 to the control module 16 or which serves for forwarding control information to the wheels 4. A storage device 17 is arranged in the C-arm 1 and serves for storing information required for repeating actions (movements, settings, irradiation processes). The storage device 17 can be integrated in the module 16. However, it can e.g. also be arranged externally or outside the C-arm 1 and exchange information with the module 16 by means of wireless communication. Via the interface 50, by means of a control command forwarded to the control module 16, it is possible to instigate a repetition of actions in accordance with information stored in the storage device 17. Visual feedback concerning the repeated action is then provided by a display interface 19.

FIG. 6 shows a C-arm with a control module 50, as illustrated in FIG. 4. The C-arm has a motor 51 and wheels 52. A collision avoidance sensor 53 is additionally provided. The various degrees of freedom in accordance with FIG. 3 are indicated by arrows.

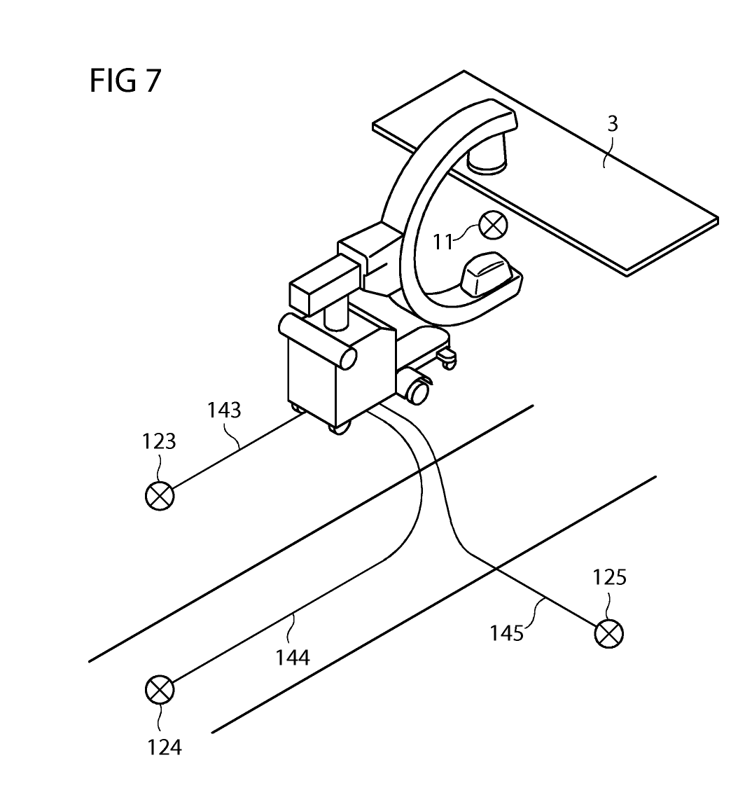

FIG. 7 shows, finally, that different paths 143, 144 and 145 proceeding from corresponding parked positions 123, 124, 125 in order to move to a target position 11 can also be stored.

The invention has been illustrated above on the basis of an example. This example is purely illustrative and merely constitutes one possible configuration of the inventive concept. The concept can be extended to arbitrary mobile medical apparatuses and used in various configurations therein, this being part of the inventive content of this application.

1. A mobile medical apparatus, comprising:
movement means for moving the entire mobile medical apparatus;
a detection device configured for detecting a movement of the mobile medical apparatus;
a storage device for storing information describing the movement of the mobile medical apparatus; and
a control interface for inputting a control command to the mobile medical apparatus for repeating the movement in accordance with stored information describing the movement to be repeated of the mobile medical apparatus.

2. The mobile medical apparatus according to claim 1, wherein the mobile medical apparatus is configured, in response to an inputting of the control command, to automatically repeat the movement or to output information for a manually performed repetition of the movement.

3. The mobile medical apparatus according to claim 1, further comprising:
a movable component, said detection device is configured for detecting a movement of said movable component and said storage device configured for storing the information describing the movement of said movable component; and
said control interface configured for inputting a further control command to the mobile medical apparatus for repeating the movement in accordance with stored information describing the movement of said movable component.

4. The mobile medical apparatus according to claim 3, wherein:
said detection device is configured for detecting a combined movement, consisting of the movement of the entire mobile medical apparatus and the movement of the movable component of the mobile medical apparatus;
said storage system is configured for storing further information describing the combined movement; and
said control interface is configured for inputting another control command to the mobile medical apparatus for repeating the combined movement in accordance with stored further information describing the combined movement.

5. The mobile medical apparatus according to claim 1, wherein the information describing the movement contains position information, path information or a combination of the position information and the path information.

6. The mobile medical apparatus according to claim 1, wherein:
said detection device is configured for detecting a parameter relevant for a diagnosis or a treatment;
said storage device is configured for storing the parameter relevant for the diagnosis or the treatment; and
said control interface configured for inputting a further control command to the mobile medical apparatus for repeating the diagnosis or the treatment by means of the mobile medical apparatus using the parameter relevant for the diagnosis or the treatment.

7. The mobile medical apparatus according to claim 1, further comprising a control element having said at least one control interface for activating detection and storage of information regarding the movement of the entire mobile medical apparatus and/or a component of the mobile medical apparatus, and/or for the activation of detection of at least one parameter relevant for a diagnosis or a treatment.

8. The mobile medical apparatus according to claim 1, further comprising a device for avoiding collisions.
